(19) United States
(12) Patent Application Publication
(10) Pub. No.: US 2005/0182158 A1
(43) Pub. Date: Aug. 18, 2005

(54) Microgels in crosslinkable organic media

(76) Inventors: Torsten Ziser, Birkenau (DE); Ludger Heiliger, Neustadt (DE); Thomas Fruh, Limburgerhof (DE); Werner Obrecht, Moers (DE)

Correspondence Address: LANXESS CORPORATION, 111 RIDC PARK WEST DRIVE, PITTSBURGH, PA, 15275-1112, US

(21) Appl. No.: 10/947,875

(22) Filed: Sep. 23, 2004

(30) Foreign Application Priority Data
Sep. 27, 2003 (DE) 103 44 976.0

(51) Int. Cl. C08K 7/16

(52) U.S. Cl. 523/223

(57) ABSTRACT

The present invention relates to a composition which contain a specific organic, crosslinkable medium and at least one microgel which is not crosslinked by high-energy radiation, processes for its preparation, uses of the compositions, microgel-containing polymers prepared therefrom and shaped articles or coatings produced therefrom.

### FIELD OF THE INVENTION

The present invention relates to a composition containing a specific organic, crosslinkable medium and at least one microgel which is not crosslinked by high-energy radiation, processes for its preparation, uses of the compositions, microgel-containing polymers prepared therefrom and shaped articles or coatings produced therefrom.

### BACKGROUND OF THE INVENTION

It is known to employ rubber gels, including modified rubber gels, in blends with the most diverse rubbers in order, for example, to improve the rolling resistance in the production of motor vehicle tyres (see e.g. DE 42 20 563, GB-PS 10 78 400, EP 405 216 and EP 854 171). In this context, the rubber gels are always incorporated into solid matrices. It is also known to incorporate printing ink pigments in finely divided form into liquid media which are suitable for these, in order finally to prepare printing inks (see e.g. EP 0 953 615 A2, EP 0 953 615 A3).

Particle sizes of up to 100 nm are achieved by this means. Various dispersing apparatuses, such as bead mills, triple-roll mills or a homogenizer, can be used for the dispersing. The use of homogenizers and the mode of functioning thereof is described in the Marketing Bulletin of APV Homogeniser Group—“High-pressure homogenisers processes, product and applications” by William D. Pandolfe and Peder Baekgaard, chiefly for the homogenization of emulsions.

The use of rubber gels as solid components in mixtures with crosslinkable organic media with the aim of preparing very finely divided rubber gel dispersions having particle diameters significantly below one μm and homogenization thereof by means of a homogenizer are not described in the documents mentioned.

Microgels which are completely crosslinked by high-energy radiation and their use for increasing the impact strength of plastics are described in Chinese Journal of Polymer Science, volume 20, no. 2, (2002), 93-98. During the preparation of specific epoxy resin compositions a mixture of a radiation-crosslinked nitrile/butadiene microgel having carboxyl end groups and the diglycidyl ether of bisphenol A intermediately occurs. Further liquid microgel-containing compositions are not described.

US 2003-0,088,036 A1 similarly discloses reinforced thermosetting resin compositions, during the preparation of which radiation-crosslinked microgel particles are likewise mixed with thermosetting prepolymers (see also EP 1262510 A1).

A radioactive cobalt source is mentioned as the preferred source of radiation for the preparation of the microgel particles in these publications.

Very homogeneously crosslinked microgel particles are obtained by the use of radiation crosslinking. However, a disadvantage of this type of crosslinking is, in particular, that transfer of this process from the laboratory scale into a large-scale industrial plant is not realistic both from economic aspects and from work safety aspects. Microgels which are not crosslinked by high-energy radiation are not used in the publications mentioned. Furthermore, the change in modulus from the matrix phase to the dispersed phase is direct if completely radiation-crosslinked microgels are used. Consequently, under sudden stress breaking effects can occur between the matrix and the dispersed phase, as a result of which the mechanical properties, the swelling properties and the stress cracking corrosion etc. are impaired.

No indications of the use of microgels which are not crosslinked by high-energy radiation are to be found in the publications mentioned.

It has now been discovered that it is possible for microgels which are not crosslinked by high-energy radiation to be distributed in fine division in crosslinkable organic media of a certain viscosity, for example using a homogenizer. Division of the microgels in the crosslinkable organic medium down to the primary particle range is, for example, a prerequisite for rendering the nano-properties of the microgels utilizable in any uses, for example in the case of incorporation into plastics.

The compositions according to the present invention contain specific microgels and crosslinkable organic media can open up a large number of new uses of microgels which were not accessible with the microgels themselves.

The microgel-containing liquids thus open up new possible applications, such as e.g. casting, injection moulding and coating, which have the liquid state as a prerequisite.

On the basis of the fine divisions which can be achieved, for example, plastics with completely new properties can be obtained by polymerization of the compositions according to the present invention containing crosslinkable organic media and a microgel. The microgel-containing compositions according to the present invention can be used in a large number of fields, such as e.g. in elastomeric PU systems (cold-cast systems and hot-cast systems).

In the microgel-containing compositions according to the present invention, materials which are incompatible per se surprisingly form a homogeneous distribution, which also remains stable during a relatively long storage period (6 months).

P. Pötschke et al., Kautschuk Gummi Kunststoffe, 50 (11) (1997) 787 show that in the case of incompatible materials, such as e.g. a p-phenylenediamine derivative as the dispersed phase and a TPU as the surrounding phase, no domains smaller than 1.5 μm can be realized. It is surprising that such small dispersed phases can be achieved with the microgels of the present invention.

Microgel-containing compositions for which the most diverse Theological properties have been determined have furthermore been found. A very high structural viscosity or thixotropy has surprisingly been found in suitable microgel-containing compositions. This can be utilized in order to control in a purposeful manner, in addition to other properties, the flow properties of any desired liquid, crosslinkable compositions by means of microgels. Surprisingly, an improved tear propagation resistance has been found in plastics prepared from the microgel-containing compositions according to the present invention.

### SUMMARY OF THE INVENTION

The present invention is directed to a composition containing at least one crosslinkable organic medium (A) which has a viscosity of less than 1,000 mPas at a temperature of 120° C. and at least one microgel (B) which is not crosslinked by high-energy radiation.

Preferably, the viscosity of the crosslinkable organic medium (A) is less than 750 mPas at a temperature of 120° C., more preferably less than 500 mPas at a temperature of 120° C.

The viscosity of the crosslinkable organic medium (A) is determined at a speed of 5 s⁻¹ in a ball-plate measuring system in accordance with DIN 53018, at 120° C.

### BRIEF DESCRIPTION OF THE DRAWINGS

FIG. 1 illustrates the mode of functioning of a homogenizing valve.

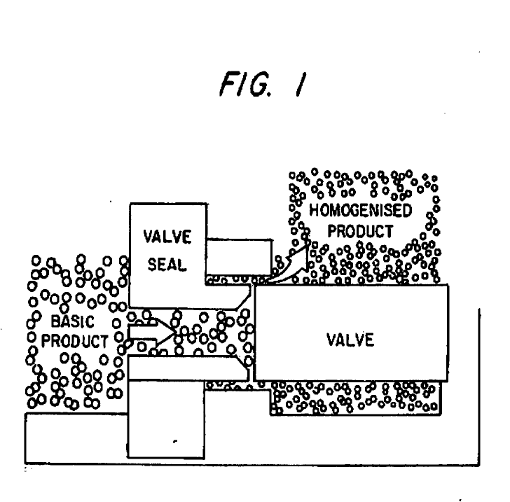

FIG. 2 illustrates a TEM photograph of a PU system (E) prepared from a composition according to the present invention and RC-DUR 120; scale 5 μm (5,000 fold).

FIG. 3 illustrates a TEM photograph of a PU system (E) prepared from a composition according to the present invention and RC-DUR 120; scale 500 nm (5,000 fold).

FIG. 4 illustrates a graph of the breaking stress curve for the system “RC-Phen 123-RFL 403B-RC DUR 110” (machine processing).

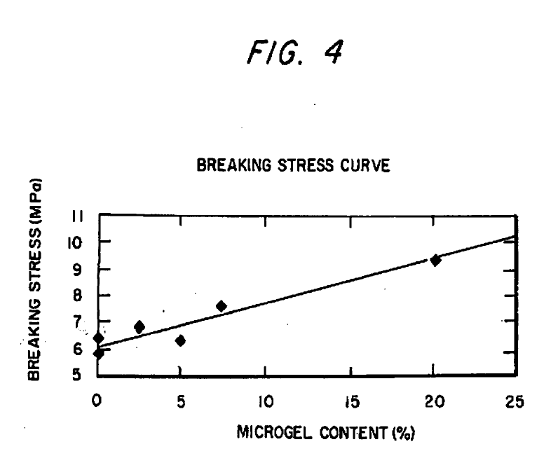

FIG. 5 illustrates a graph of the strengthening 50% elongation of the system “RC-Phen 123-RFL 403B-RC DUR 110”.

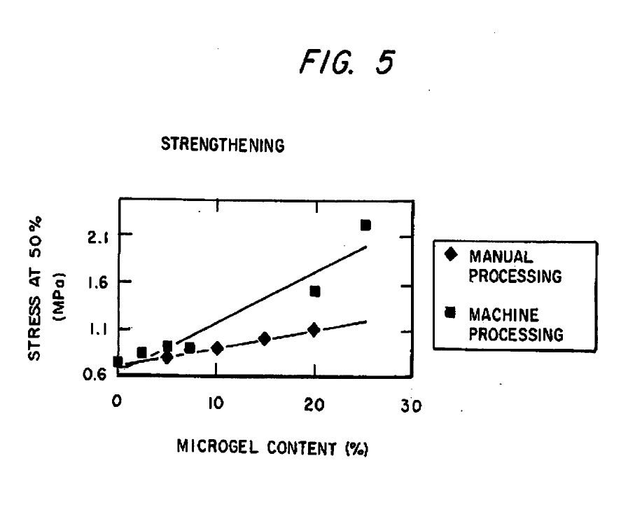

FIG. 6 illustrates a graph of the strengthening for the system “RC-Phen 123-RFL 403B-RC DUR 110” (machine processing).

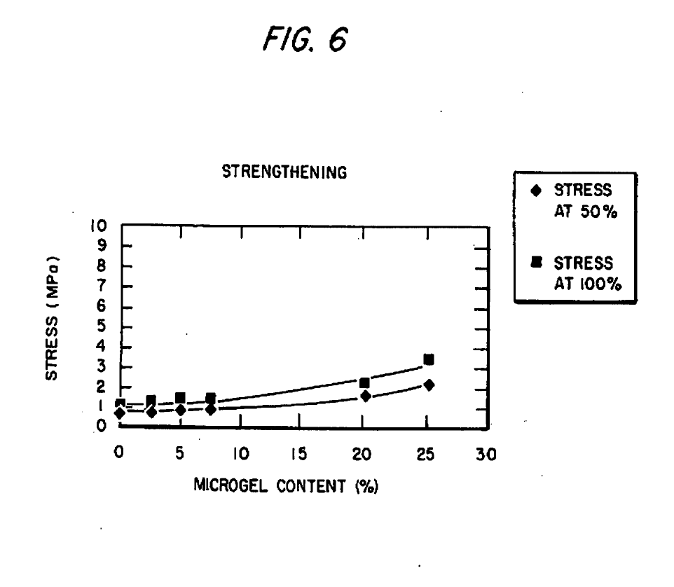

FIG. 7 illustrates a hardness graph f the system “RC-Phen 123-RFL 403B-RC DUR 110” (machine processing).

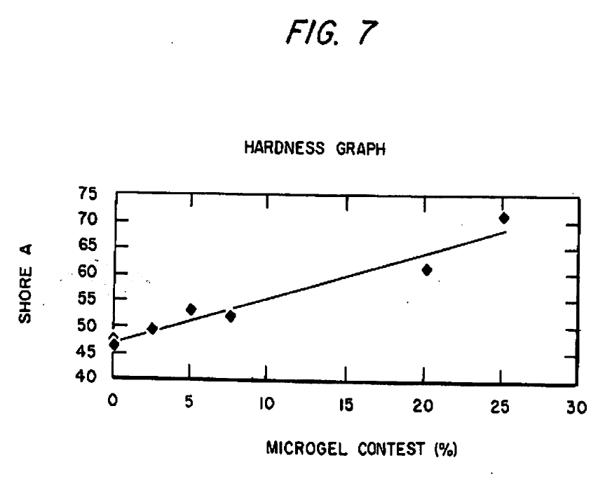

FIG. 8 illustrates a graph of the tear propagation resistance of the system “RC-Phen 123-RFL 403B-RC DUR 110” (machine processing).

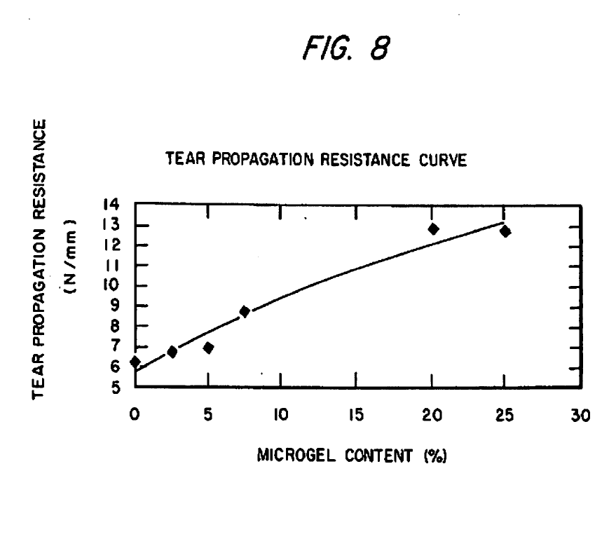

FIG. 9 illustrates that solid OBR 1212 can be successfully redispersed in Desmophen 1600U with an average particle diameter of the OBR latex and the redispersed OBR 1212 scarcely differ.

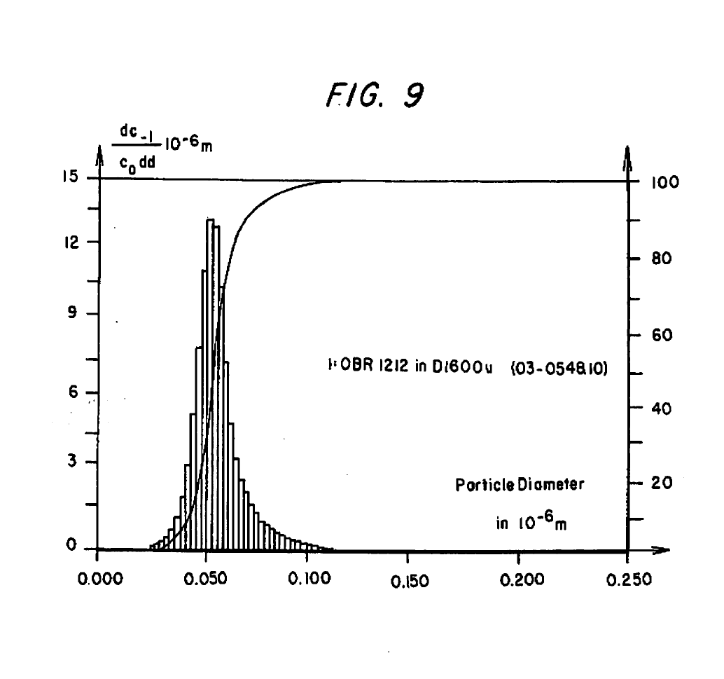

FIG. 10 illustrates that differential particle size distribution OBR 1212 latex and of OBR 1212, redispersed in Desmophen 1600U, in comparison.

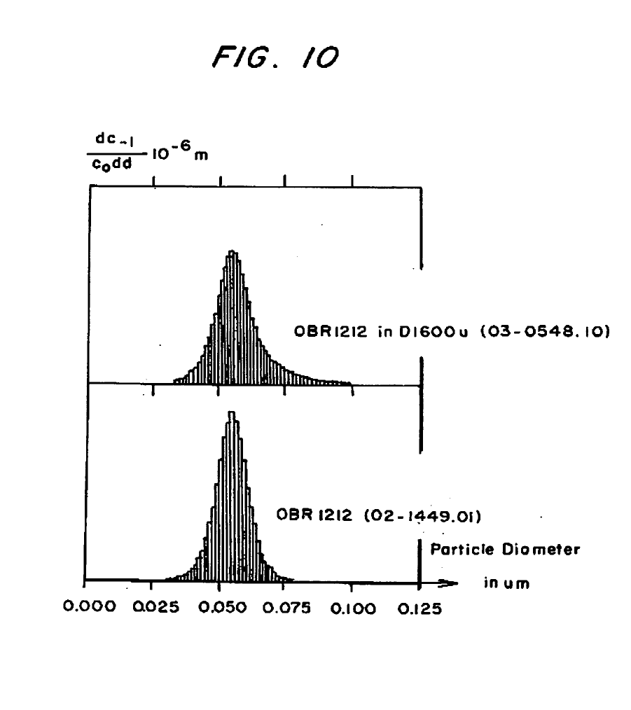

### DETAILED DESCRIPTION OF THE INVENTION

Microgels (B)

The microgel (B) used in the composition according to the invention is a microgel which is not crosslinked by high-energy radiation. High-energy radiation here expediently means electromagnetic radiation of a wavelength of less than 0.1 μm.

The use of microgels which are completely homogeneously crosslinked by high-energy radiation is a disadvantage because in practice it cannot be implemented on a large industrial scale and causes work safety problems. Furthermore, in compositions which have been prepared using microgels which are completely homogeneously crosslinked by high-energy radiation, breaking effects between the matrix and the dispersed phase occur under sudden stress, as a result of which the mechanical properties, the swelling properties and the stress cracking corrosion etc. are impaired.

Preferably, the primary particles of the microgel (B) have an approximately spherical geometry. According to DIN 53206:1992-08, the microgel particles dispersed in the coherent phase which are detectable as individuals by suitable physical methods (electron microscope) are called primary particles (cf. e.g. Römpp Dictionary, Lacke und Druckfarben, Georg Thieme Verlag, 1998). An “approximately spherical” geometry means that the dispersed primary particles of the microgels are detectably substantially imaged as a circular area when the composition is viewed, for example, with an electron microscope. Since the microgels substantially do not change their shape during crosslinking of the crosslinkable organic medium (A), the statements above and below also apply in the same manner to the microgel-containing compositions obtained by crosslinking of the composition according to the present invention.

In the primary particles of the microgel (B) which are contained in the composition according to the invention, the deviation of the diameter of an individual primary particle, defined as
[(d1−d2)/d1]×100
wherein d1 and d2 are any two desired diameters of the primary particle and d1>d2, is preferably less than 250%, more preferably less than 200%, most preferably less than 100%.

Preferably, at least 80%, more preferably at least 90%, most preferably at least 95% of the primary particles of the microgel have a deviation of the diameter, defined as
[(d1−d2)/d1]×100
wherein d1 and d2 are any two desired diameters of the primary particle and d1>d2, of less than 250%, more preferably less than 200%, most preferably less than 100%.

The abovementioned deviation in the diameters of the individual particles is determined by the following method. A thin section of the composition according to the present invention is first prepared as described in the examples. A transmission electron microscopy photograph is then produced at a magnification of, for example, 10,000-fold or 200,000-fold. In an area of 833.7×828.8 nm, the largest and the smallest diameter is determined manually as d1 and d2 on 10 microgel primary particles. If the deviation on all 10 microgel primary particles is in each case less than 250%, more preferably less than 200%, most preferably less than 100%, the microgel primary particles have the deviation feature defined above.

If the concentration of the microgels in the composition is so high that there is marked overlapping of the visible microgel primary particles, the evaluability can be improved by prior suitable dilution of the measurement sample. In the composition according to the present invention, the primary particles of the microgel (B) preferably have an average particle diameter of 5 to 500 nm, more preferably 20 to 400 nm, most preferably 50 to 300 nm (diameter data in accordance with DIN 53206). Since the morphology of the microgels substantially does not change during the polymerization or crosslinking of the composition according to the present invention, the average particle diameter of the dispersed primary particles substantially corresponds to the average particle diameter of the dispersed primary particles in the composition obtained by polymerization or crosslinking.

In the composition according to the present invention, the microgels (B) have contents which are insoluble in toluene at 23° C. (gel content) of at least about 70 wt. %, more preferably at least about 80 wt. %, most preferably at least about 90 wt. %. The content which is insoluble in toluene is determined here in toluene at 23° C. In this determination, 250 mg of the microgel are swollen in 20 ml toluene at 23° C. for 24 hours, while shaking. After centrifugation at 20,000 rpm, the insoluble content is separated off and dried. The gel content is obtained from the difference between the amount weighed out and the dried residue and is stated in percent.

In the composition according to the present invention, the microgels (B) expediently have a swelling index in toluene at 23° C. of less than about 80, more preferably less than 60, most preferably less than 40. The swelling indices of the microgels (Qi) can thus particularly preferably be between 1-15 and 1-10. The swelling index is calculated from the weight of the solvent-containing microgel (after centrifugation with 20,000 rpm) which has been swollen in toluene at 23° C. for 24 hours and the weight of the dry microgel:
Qi=wet weight of the microgel/dry weight of the microgel.

To determine the swelling index, exactly 250 mg of the microgel are swollen in 25 ml toluene for 24 h, while shaking. The gel is centrifuged off and weighed, and then dried to constant weight at 70° C. and weighed again.

In the composition according to the present invention, the microgels (B) have glass transition temperatures Tg of −100° C. to +100° C., more preferably −80° C. to +80° C.

The microgels (B) employed in the composition according to the present invention furthermore have a range of the glass transition of greater than 5° C., preferably greater than 10° C., more preferably greater than 20° C. Microgels which have such a range of the glass transition are as a rule—in contrast to completely homogeneously radiation-crosslinked microgels—not completely homogeneously crosslinked. This means that the change in modulus from the matrix phase to the dispersed phase in the crosslinkable or polymerized compositions prepared from the compositions according to the present invention is not direct. Consequently, under sudden stress of these compositions breaking effects do not occur between the matrix and the dispersed phase, as a result of which the mechanical properties, the swelling properties and the stress cracking corrosion etc. are advantageously influenced.

The determination of the glass transition temperatures (Tg) and of the range of the glass transition (ΔTg) of the microgels is carried out by differential thermal analysis (DTA; differential scanning calorimetry DSC) under the following conditions:

For the determination of Tg and ΔTg, two cooling/heating cycles are carried out. Tg and ΔTg are determined in the second heating cycle. For the determinations, 10-12 mg of the chosen microgel are placed in a DSC sample container (standard aluminium pan) from Perkin-Elmer. The first DSC cycle is carried out by first cooling the sample to −100° C. with liquid nitrogen and then heating it up to +150° C. at a rate of 20 K/min. The second DSC cycle is started by immediate cooling of the sample as soon as a sample temperature of +150° C. is reached. The cooling is carried out at a rate of approximately 320 K/min. In the second heating cycle, the sample is once again heated up to +150° C. as in the first cycle. The rate of heating in the second cycle is again 20 K/min. Tg and ΔTg are determined on the graph of the DSC curve of the second heating operation. For this purpose, three straight lines are laid on the DSC curve. The 1st straight line is laid on the curve part of the DSC curve below Tg, the 2nd straight line on the curve branch running through Tg with the point of inflection and the 3rd straight line on the curve branch of the DSC curve above Tg. Three straight lines with two points of intersection are obtained in this manner. The two points of intersection are each identified by a characteristic temperature. The glass transition temperature Tg is obtained as the mean of these two temperatures, and the range of the glass transition ΔTg is obtained from the difference between the two temperatures.

The microgels (B) which are contained in the composition according to the present invention and are not crosslinked by high-energy radiation, which are preferably based on homopolymers or random copolymers, can be prepared in a manner known per se (see, for example, EP-A-405 216, EP-A-854171, DE-A 4220563, GB-PS 1078400, DE 197 01 489.5, DE 197 01 488.7, DE 198 34 804.5, DE 198 34 803.7, DE 198 34 802.9, DE 199 29 347.3, DE 199 39 865.8, DE 199 42 620.1, DE 199 42 614.7, DE 100 21 070.8, DE 100 38 488.9, DE 100 39 749.2, DE 100 52 287.4, DE 100 56 311.2 and DE 100 61 174.5. The use of CR, BR and NBR microgels in mixtures with rubbers containing double bonds is claimed in the patents (patent applications) EP-A 405 216, DE-A 4220563 and in GB-PS 1078400. The use of subsequently modified microgels in mixtures with rubbers containing double bonds, such as NR, SBR and BR is described in DE 197 01 489.5.

Microgels are understood as meaning rubber particles which are obtained preferably by crosslinking of the following rubbers:
BR: polybutadiene,
ABR: butadiene/acrylic acid C1-4 alkyl ester copolymers,
IR: polyisoprene,
SBR: styrene/butadiene copolymers having styrene contents of 1-60, preferably 5-50 percent by weight,
X-SBR: carboxylated styrene/butadiene copolymers,
FKM: fluorinated rubber,
ACM: acrylate rubber,
NBR: polybutadiene/acrylonitrile copolymers having acrylonitrile contents of 5-60, preferably 10-50 percent by weight,
X-NBR: carboxylated nitrile rubbers,
CR: polychloroprene,
IIR: isobutylene/isoprene copolymers having isoprene contents of 0.5-10 percent by weight,
BIIR: brominated isobutylene/isoprene copolymers having bromine contents of 0.1-10 percent by weight,
CIIR: chlorinated isobutylene/isoprene copolymers having chlorine contents of 0.1-10 percent by weight,
HNBR: partly and completely hydrogenated nitrile rubbers,
EPDM: ethylene/propylene/diene copolymers,
EAM: ethylene/acrylate copolymers,
EVM: ethylene/vinyl acetate copolymers,
CO and
ECO: epichlorohydrin rubbers,
Q: silicone rubbers,
AU: polyester-urethane polymers,
EU: polyether-urethane polymers,
ENR: epoxidized natural rubber or mixtures thereof.

The non-crosslinked microgel starting substances are preferably prepared by the following methods:
1. emulsion polymerisation
2. solution polymerization of rubbers which are not accessible via variant 1,
3. furthermore, naturally occurring latices, such as e.g. natural rubber latex, can be employed.

In the composition according to the present invention, the microgels (B) used are preferably those which are obtainable by emulsion polymerization and crosslinking.

The following monomers which can be polymerized by free-radical polymerization are employed, for example, in the preparation, by emulsion polymerization, of the microgels used according to the present invention: butadiene, styrene, acrylonitrile, isoprene, esters of acrylic and methacrylic acid, tetrafluoroethylene, vinylidene fluoride, hexafluoropropene, 2-chlorobutadiene, 2,3-dichlorobutadiene as well as carboxylic acids containing double bonds, such as e.g. acrylic acid, methacrylic acid, maleic acid, itaconic acid etc., hydroxy compounds containing double bonds, such as e.g. hydroxyethyl methacrylate, hydroxyethyl acrylate and hydroxybutyl methacrylate, amine-functionalized (meth)acrylates, acrolein, N-vinyl-2-pyrrolidone, N-allyl-urea and N-allyl-thiourea as well as secondary amino-(meth)acrylic acid esters, such as 2-tert-butylaminoethyl methacrylate, and 2-tert-butylaminoethylmethacrylamide etc. The crosslinking of the rubber gel can be achieved directly during the emulsion polymerization, such as by copolymerization with multifunctional compounds having a crosslinking action, or by subsequent crosslinking, as described below. Preferred multifunctional comonomers are compounds having at least two, preferably 2 to 4 copolymerizable C═C double bonds, such as diisopropenylbenzene, divinylbenzene, divinyl ether, divinyl sulfone, diallyl phthalate, triallyl cyanurate, triallyl isocyanurate, 1,2-poly-butadiene, N,N′-m-phenylenemaleimide, 2,4-toluylenebis(maleimide) and/or triallyl trimellitate. Compounds which are furthermore possible are the acrylates and methacrylates of polyhydric, preferably 2- to 4-hydric C2 to C10 alcohols, such as ethylene glycol, propane-1,2-diol, butanediol, hexanediol, polyethylene glycol with 2 to 20, preferably 2 to 8 oxyethylene units, neopentylglycol, bisphenol A, glycerol, trimethylolpropane, pentaerythritol or sorbitol, with unsaturated polyesters from aliphatic di- and polyols, as well as maleic acid, fumaric acid and/or itaconic acid.

The crosslinking to form rubber microgels during the emulsion polymerization can also take place by continuing the polymerization up to high conversions, or in the monomer feed process by polymerization with high internal conversions. Another possibility is also to carry out the emulsion polymerization in the absence of regulators.

The latices which are obtained in the emulsion polymerization are best employed for the crosslinking of the non-crosslinked or weakly crosslinked microgel starting substances after the emulsion polymerization. In principle, this method can also be used on non-aqueous polymer dispersions which are accessible in a different manner, such as e.g. by redissolving. Natural rubber latices can also be crosslinked in this manner.

Suitable chemicals having a crosslinking action are, for example, organic peroxides, such as dicumyl peroxide, t-butyl cumyl peroxide, bis-(t-butyl-peroxy-isopropyl)benzene, di-t-butyl peroxide, 2,5-dimethylhexane-2,5-dihydroperoxide, 2,5-dimethyl-3-hexyne 2,5-dihydroperoxide, dibenzoyl peroxide, bis-(2,4-dichlorobenzoyl)peroxide or t-butyl perbenzoate as well as organic azo compounds, such as azo-bis-isobutyronitrile and azo-bis-cyclohexanenitrile, as well as di- and polymercapto compounds, such as dimercaptoethane, 1,6-dimercaptohexane, 1,3,5-trimercaptotriazine and mercapto-terminated polysulfide rubbers, such as mercapto-terminated reaction products of bis-chloroethylformal with sodium polysulfide.

The optimum temperature for carrying out the post-crosslinking of course depends on the reactivity of the crosslinking agent, and the reaction can be carried out at temperatures from room temperature up to approx. 180° C., optionally under increased pressure (in this context see Houben-Weyl, Methoden der organischen Chemie, 4th edition, volume 14/2, page 848). Peroxides are preferred crosslinking agents.

The crosslinking of rubbers containing C═C double bonds to give microgels can also be carried out in dispersion or emulsion with simultaneous, partial or optionally complete hydrogenation of the C═C double bond by means of hydrazine, as described in U.S. Pat. No. 5,302,696 or U.S. Pat. No. 5,442,009, or optionally other hydrogenating agents, for example organometallic hydride complexes.

An increase in particle size by agglomeration can optionally be carried out before, during or after the post-crosslinking.

Microgels which are not completely homogeneously crosslinked and can have the advantages described above are always obtained in the preparation process used according to the present invention.

Rubbers which are prepared by solution polymerization can also be used as starting substances for the preparation of the microgels. In these cases the solutions of these rubbers in suitable organic solutions are the starting materials.

The desired sizes of the microgels is established by a procedure in which the rubber solution is mixed in a liquid medium, preferably in water, optionally with the addition of suitable surface-active auxiliary substances, such as e.g. surfactants, by means of suitable units, so that a dispersion of the rubber in the suitable particle size range is obtained. The procedure for the crosslinking of the dispersed solution rubbers is as described above for the subsequent crosslinking of emulsion polymers. Suitable crosslinking agents are the abovementioned compounds, it being possible for the solvent employed for the preparation of the dispersion optionally to be removed, e.g. by distillation, before the crosslinking.

Microgels which can be used for the preparation of the composition according to the present invention are both non-modified microgels which substantially contain no reactive groups, in particular on the surface, and modified microgels modified with functional groups, preferably on the surface. The latter can be prepared by chemical reaction of the already crosslinked microgels with chemicals which are reactive towards C═C double bonds. These reactive chemicals are, in particular, those compounds with the aid of which polar groups, such as e.g. aldehyde, hydroxyl, carboxyl, nitrile etc. and sulfur-containing groups, such as e.g. mercapto, dithiocarbamate, polysulfide, xanthogenate, thiobenzothiazole and/or dithiophosphoric acid groups and/or unsaturated dicarboxylic acid groups, can be bonded chemically to the microgels. This also applies to N,N′-m-phenylenediamine. The aim of the microgel modification is improvement in the microgel compatibility when the composition according to the present invention is used for the preparation of the later matrix into which the microgel is incorporated, or the composition according to the present invention is used for incorporation into a matrix, in order to achieve a good ability to be distributed during the preparation as well as a good coupling.

Preferred methods of modification are grafting of the microgels with functional monomers, and reaction with low molecular weight agents.

The starting material preferably used for the grafting of the microgels with functional monomers is the aqueous microgel dispersion, which is reacted with polar monomers, such as acrylic acid, methacrylic acid, itaconic acid, hydroxyethyl(meth)acrylate, hydroxypropyl(meth)acrylate, hydroxybutyl (meth)acrylate, acrylamide, methacrylamide, acrylonitrile, acrolein, N-vinyl-2-pyrrolidone, N-allyl-urea and N-allyl-thiourea, as well as secondary amino-(meth)acrylic acid esters, such as 2-tert-butylaminoethyl methacrylate and 2-tert-butylaminoethylmethacrylamide, under the conditions of a free-radical emulsion polymerization. Microgels having a core/shell morphology are obtained in this manner, where the shell should have a high compatibility with the matrix. It is desirable for the monomer used in the modification step to be grafted as quantitatively as possible on to the non-modified microgel. The functional monomers are preferably metered in before complete crosslinking of the microgels.

Grafting of the microgels in non-aqueous systems is also conceivable in principle, modification with monomers by ionic polymerization methods also becoming possible in this manner.

The following reagents are possible preferably for surface modification of the microgels with low molecular weight agents: elemental sulfur, hydrogen sulfide and/or alkylpolymercaptans, such as 1,2-dimer-captoethane or 1,6-dimercaptohexane, and moreover dialkyl- and dialkylaryidithiocarbamate, such as the alkali metal salts of dimethyl-dithiocarbamate and/or dibenzyldithiocarbamate, and furthermore alkyl- and arylxanthogenates, such as potassium methylxanthogenate and sodium isopropylxanthogenate, as well as reaction with the alkali metal or alkaline earth metal salts of dibutyldithiophosphoric acid and dioctyldithiophosphoric acid as well as dodecyidithiophosphoric acid. The reactions mentioned can advantageously also be carried out in the presence of sulfur, the sulfur also being incorporated, with the formation of polysulfidic bonds. Free radical initiators, such as organic and inorganic peroxides and/or azo initiators, can be added for addition of this compound.

Modification of microgels containing double bonds, such as e.g. by ozonolysis as well as by halogenation with chlorine, bromine and iodine, is also possible. Further reaction of modified microgels, such as e.g. the preparation of microgels modified with hydroxyl groups from epoxidized microgels, is also understood as chemical modification of microgels.

Preferably, the microgels are modified by hydroxyl groups, preferably also on the surface thereof. The hydroxyl group content of the microgels is determined as the hydroxyl number with the dimension mg KOH/g polymer by reaction with acetic anhydride and titration of the acetic acid thereby liberated with KOH in accordance with DIN 53240. The hydroxyl number of the microgels is preferably between 0.1-100, more preferably between 0.5-50 mg KOH/g polymer.

The amount of modifying agent employed depends on the activity thereof and the requirements imposed in the individual case, and is in the range from 0.05 to 30 percent by weight, based on the total amount of rubber microgel employed, 0.5-10 percent by weight, based on the total amount of rubber gel, being preferred.

The modification reactions can be carried out at temperatures of 0-180° C., preferably 20-95° C., optionally under a pressure of 1-30 bar. The modifications can be carried out on rubber microgels as the substance or in the form of their dispersion, it being possible to use inert organic solvents or also water as the reaction medium in the last case. The modification is preferably carried out in an aqueous dispersion of the crosslinked rubber.

The use of non-modified microgels is preferred in the case of compositions according to the present invention which contain crosslinkable media which lead to the formation of non-polar thermoplastic materials (A), such as, for example, polypropylene, polyethylene and block copolymers based on styrene, butadiene and isoprene (SBR, SIR), as well as hydrogenated isoprene/styrene block copolymers (SEBS), and conventional TPE-Os and TPE-Vs etc.

The use of modified microgels is preferred in the case of compositions according to the present invention which contain crosslinkable media which lead to the formation of polar thermoplastic materials (A), such as, for example, PA, TPE-A, PU, TPE-U, PC, PET, PBT, POM, PMMA, PVC, ABS, PTFE, PVDF etc.

The average diameter of the microgels prepared can be established with a high degree of accuracy, for example at 0.1 micrometer (100 nm)±0.01 micrometer (10 nm), so that, for example, a particle size distribution in which at least 75% of all microgel particles are between 0.095 micrometer and 0.105 micrometer in size is achieved. Other average diameters of the microgels, such as in the range between 5 to 500 nm, can be established with the same accuracy (at least 75 wt. % of all particles are around the maximum of the integrated particle size distribution curve (determined by light scattering) in a range of ±10% above and below the maximum) and can be employed. As a result, the morphology of the microgels dispersed in the composition according to the present invention can be established practically with “point accuracy” and the properties of the composition according to the present invention and of the plastics prepared, for example, therefrom can thus be established.

The microgels prepared in this way can be worked up, for example, by evaporation, coagulation, by co-coagulation with a further latex polymer, by freeze-coagulation (cf. U.S. Pat. No. 2,187,146) or by spray drying. Commercially available flow aids, such as, for example, CaCO₃ or silica, can also be added in the working up by spray drying.

Preferably the composition according to the present invention, the microgel (B) is based on rubber.

Preferably according to the present invention, the microgel (B) is modified by functional groups which are reactive towards C═C double bonds.

Preferably, the microgel (B) has a swelling index in toluene at 23° C. of 1 to 15.

The composition according to the present invention preferably has a viscosity of 25 mPas to 5,000,000 mPas, more preferably 200 mPas to 3,000,000 mPas at a speed of 5 s⁻¹ in a ball/plate viscometer in accordance with DIN 53018 at 20° C.

Organic, Crosslinkable Medium (A)

The composition according to the present invention contains at least one organic medium (A) which has a viscosity at a temperature of 120° C. of less than 1,000 mpas, preferably 750 mPas, more preferably 500 mPas.

The viscosity of the crbsslinkable organic medium (A) is determined at a speed of 5 s⁻¹ in a ball/plate measuring system in accordance with DIN 53018 at 120° C.

Such a medium is liquid to solid at room temperature (20° C.), preferably liquid or flowable.

Organic medium in the context of the invention means that the medium contains at least one carbon atom.

The crosslinkable organic media (A) are preferably those which can be crosslinked via functional groups containing heteroatoms or C═C groups.

Crosslinkable media which are liquid at room temperature (20° C.) and in general are cured to plastics by reaction with a further component (C), by free-radical, in particular peroxidic crosslinking in the presence-of free radical initiators or by UV radiation, as described in the following, are preferably employed as component (A).

The choice of a component (C), which is suitable for crosslinking, for a suitable crosslinkable organic medium (A) are known to those skilled in the art, and reference may be made to the relevant technical literature.

The liquid, crosslinkable organic media (A) which are suitable for the preparation of the compositions according to the present invention are, for example, polyols based on polyester, polyether or polyether-polyester, and epoxy resins, unsaturated polyester resins and acrylate resins. These resins and their curing agents are characterized in that one component has a functionality close to 2.0 and the other has a functionality of 2 to 2.5, so that polymers which are linear or weakly branched but are not chemically crosslinked are formed.

Suitable polyester polyols are prepared by condensation of dicarboxylic acids with excess amounts of di- or polyols or are based on caprolactones¹⁾.

Polyether polyols which are preferably employed are those based on propylene oxide and/or ethylene oxide. Polyoxytetramethylene glycols are also useful.

The addition of alkylene oxides on to di- or polyamines leads to nitrogen-containing basic polyethers. The polyols mentioned are preferably reacted with aromatic isocyanates, such as TDI (toluylene-diisocyanate) or MDI (methylenediphenyl-diisocyanate), and in certain cases also with NDI (naphthalene-1,5-diisocyanate) or TODI (3,3′-dimethyl-4,4′-diisocyanato-biphenyl) and derivatives thereof, aromatic polyisocyanates on the same basis or aliphatic isocyanates (HDI, IPDI, H₁₂MDI (4,4′-dicyclohexyl-methane-diisocyanate), HTDI (methylcyclohexyl-diisocyanate), XDI (xylylene-diisocyanate), TMDI (trimethylhexamethylene-diisocyanate), DMI (dimeryl-diisocyanate)) or aliphatic polyisocyanates on the same basis as the trimer of HDI (hexamethylene-diisocyanate) or of IPDI (isophorone-diisocyanate).

Epoxy resins are cured with aminic curing agents, amine adducts, amines or polyamines or acid anhydrides.

Epoxy resins are prepared by reaction of phenols or alcohols with epichlorohydrin. The resin which is also important in terms of amount is bisphenol A diglycidyl ether, in addition to bisphenol F diglycidyl ether. Further epoxy resins are the extenders, such as hexane diglycidyl ether, the epoxide novolaks, the glycidyl esters, the glycidylamines, the glycidyl isocyanurates and the cycloaliphatic epoxides.

Suitable amines are the aliphatic and cycloaliphatic amines, such as diethylenetriamine (DETA), triethylenetetramine (TETA), 3,3′,5-trimethyl-hexamethylenediamine (TMD), isophoronediamine (IPD) and m-xylylene-diamine (MXDA), the aromatic amines, such as methylenedianiline (MDA) and 4,4′-diaminodiphenyl sulfone (DDS), amine adducts, such as e.g. of TMD and bisphenol A diglycidyl ether and DETA-phenol Mannich base, polyaminoamides as formed in amide formation from polyethyleneamines and monomer and dimer fatty acids, and dicyandiamide. Amines of low functionality include the corresponding alkylated types.

Cyclic acid anhydrides are e.g. phthalic anhydride (PA) and hexahydrophthalic anhydride.

Unsaturated polyester resins include linear, soluble polycondensation products from chiefly maleic or fumaric acid and dihydric alcohols, which can be dissolved in a monomer capable of copolymerization, usually styrene, and are polymerized by addition of peroxides.

Acids which can be employed in the UP resins are adipic and phthalic acid, phthalic anhydride, tetrahydrophthalic acid, isophthalic acid, terephthalic acid, tetrachlorophthalic acid, tetrabromophthalic acid, het acid and endo-methylene-tetrahydrophthalic anhydride. Diols for UP resins which are employed are chiefly 1,2- and 1,3-propanediol, ethylene glycol, diethylene glycol, dipropylene glycol and monoallyl ethers of glycerol and trimethylolpropane.

Monomers useful, in addition to other polymerizable monomers, e.g. styrene, alpha-methylstyrene, methyl acrylate, methyl methacrylate and vinyl acetate.

The crosslinking of the crosslinkable composition according to the invention is preferably carried out peroxidically or by UV light or electron beams.

The vinyl esters, such as are produced by Dow—Derakane and Derakane Momentum—are similar to the unsaturated polyester resins.

Further possible crosslinkable media include methyl methacrylate, alkyl methacrylates, alkyl acrylates or mixtures with comonomers, such as methacrylates or acrylates, which are cured by peroxides or UV radiation/electron beams. Polymers or copolymers of the monomers mentioned can also be dissolved in the materials described above. Monomers, such as e.g. 2-ethylhexyl acrylate (EHA) and stearyl acrylate, and polyether acrylates, such as e.g. polyethylene glycol diacrylate 400 (PEG400DA), polyester acrylates, which are prepared e.g. from polyester polyols or corresponding polyol/polycarboxylic acid mixtures by esterification with acrylic acid, urethane acrylates and acrylated polyacrylates, are employed preferably for the curing with UV radiation/electron beams.

The present invention furthermore relates to the use of the composition according to the present invention for the preparation of microgel-containing polymers, as explained above.

If those components which would lead to the formation of thermoplastic polymers are used as the crosslinkable component (A), it is found, surprisingly, that microgel-containing polymers which behave like thermoplastic elastomers are obtained. The present invention thus also relates to thermoplastic elastomers which are obtained by polymerization or crosslinking of the compositions according to the present invention which contain component (A).

The present invention furthermore also relates to the polymers or crosslinking products, preferably thermoplastic elastomers, which are obtained by crosslinking or polymerization of the compositions containing the microgels and the crosslinkable component (A), and to the shaped articles and coatings produced therefrom by conventional processes.

The compositions according to the present invention allow a simple and uniform incorporation of microgels into polymers, as a result of which the polymers obtained surprisingly have improved properties.

The composition according to the present invention preferably contains 1 to 60 wt. %, more preferably 3-40 wt. %, most preferably 5-25 wt. % of the microgel (B), based on the total amount of the composition.

The composition according to the present invention furthermore preferably contains 10 to 99 wt. %, more preferably 30 to 95 wt. %, most preferably 40 to 90 wt. %, and furthermore more preferably 50 to 85 wt. % of the crosslinkable organic medium (A).

The composition according to the present invention preferably contains the crosslinkable organic medium (A) and the microgel (B) and optionally the further components below. The presence of water is not preferred.

The composition according to the present invention can, for example, additionally contain non-crosslinkable organic media, such as, in particular, organic solvents, saturated or aromatic hydrocarbons, polyether oils, ester oils, polyether-ester oils, phosphoric acid esters, silicon-containing oils and halogenohydrocarbons or combinations thereof, fillers, pigments, catalysts and additives, such as dispersing auxiliaries, deaerating agents, flow agents, levelling agents, auxiliary substances for wetting the substrate, adhesion promoters for controlling wetting of the substrate, for controlling the conductivity, and auxiliary substances for controlling the stability of the colour shade, the gloss and the flooding.

The additives mentioned can be incorporated uniformly into the compositions according to the present invention, which in turn leads to improvement in the polymer compositions prepared therefrom.

Suitable pigments and fillers for the preparation of the compositions according to the present invention which contain the crosslinkable medium (A) and microgel-containing plastics prepared therefrom are, for example: inorganic and organic pigments, silicatic fillers, such as kaolin and talc, carbonates, such as calcium carbonate and dolomite, barium sulfate, metal oxides, such as zinc oxide, calcium oxide, magnesium oxide and aluminium oxide, highly disperse silicas (precipitated and thermally prepared silicas), metal hydroxides, such as aluminium hydroxide and magnesium hydroxide, glass fibres and glass fibre products (mats, strands or glass microbeads), carbon fibres, thermoplastic fibres (polyamide, polyester, aramid), rubber gels based on polychloroprene and/or polybutadiene, or also all other gel particles described previously which have a high degree of crosslinking and a particle size of 5 to 1,000 nm.

The fillers mentioned can be employed by themselves or in a mixture. Preferably in the process, 1-30 parts by weight of rubber gel (B), optionally together with 0.1 to 40 parts by weight of fillers, and 30-99 parts by weight of liquid, crosslinkable medium (A) are employed for the preparation of the compositions according to the present invention.

The compositions according to the present invention can contain further auxiliary substances, such as crosslinking agents, reaction accelerators, anti-ageing agents, heat stabilizers, light stabilizers, ozone stabilizers, plasticizers, tackifiers, blowing agents, dyestuffs, waxes, extenders, organic acids and retardants, as well as filler activators, such as, for example, trimethoxysilane, polyethylene glycol and solvents, such as those mentioned above or others which are known in the industries described.

The auxiliary substances are employed in conventional amounts, which depend inter alia on the intended use. Conventional amounts are e.g. amounts of 0.1 to 80 wt. %, preferably 0.1 to 50 wt. %, based on the amount of liquid, crosslinkable medium (A) employed.

Preferably, the composition according to the present invention is prepared by means of a homogenizer, bead mill or a triple-roll mill. Disadvantages of the bead mill are the comparatively limited viscosity range (tendency towards thin compositions), high outlay on cleaning, expensive product changes of the compositions which can be used and the abrasion of the beads and grinding apparatus.

The homogenization of the compositions according to the present invention is preferably carried out by means of a homogenizer or a triple-roll mill. Disadvantages of the triple-roll mill are the comparatively limited viscosity range (tendency towards very thick compositions), low throughput and the non-closed procedure (poor work safety).

The homogenization of the compositions according to the present invention is preferably carried out by means of a homogenizer. The homogenizer allows thin and thick compositions to be processed at a high throughput (high flexibility). Product changes are possible comparatively rapidly and without problems.

The dispersing of the microgels (B) in the liquid medium (A) is carried out in the homogenizer in the homogenizing valve.

In the process employed according to the present invention, agglomerates are divided into aggregates and/or primary particles. Agglomerates are units which can be separated by physical means, during dispersing of which no change in the primary particle size takes place.

The product to be homogenized enters the homogenizing valve at a slow speed and is accelerated to high speeds in the homogenizing gap. Dispersing takes place after the gap, chiefly on the basis of turbulences and cavitation.

The temperature of the composition according to the present invention on introduction into the homogenizer is preferably −40-140° C., more preferably 20-80° C.

The composition according to the present invention to be homogenized is homogenized in the apparatus under a pressure of 200 to 4,000 bar, preferably 500-2,000 bar, more preferably 900-2,000 bar. The number of passes depends on the quality of the desired dispersing quality and can vary between one and 20 passes

The compositions prepared according to the present invention have a fine particle distribution, which is achieved in particular with the homogenizer, which is also extremely advantageous in respect of the flexibility of the process with respect to varying viscosities of the liquid media and of the resulting compositions, and the necessary temperatures and the dispersing quality (example 4).

The present invention is explained in more detail with reference to the following examples. The present invention is of course not limited to these examples.

### EXAMPLES

### Example 1

### SBR Gels Modified with Hydroxyl Groups (RFL 403A) in Desmophen 1150

It is shown in the example described in the following that a microgel composition according to the present invention having particle diameters of 220 nm and smaller can be prepared using a microgel based on SBR and modified with hydroxyl groups with a homogenizer by applying 900 to 1,000 bar.

The composition of the microgel composition according to the present invention is shown in the following table:

| | | |
|---|---|---|
| 1. | Desmophen 1150 | 79.7 |
| 2. | RFL 403A | 20 |
| 3. | Tego Airex 980 | 0.3 |
| | Total | 100 |

Desmophen 1150 is a branched polyalcohol with ester and ether groups from Bayer AG for the production of viscoelastic coatings.

Tego Airex 980, an organically modified polysiloxane, is a deaerating agent from Tego Chemie Service GmbH.

RFL 403A is a crosslinked, surface-modified rubber gel based on SBR from RheinChemie Rheinau GmbH.

RFL 403A contains 70 wt. % butadiene, 22 wt. % styrene, 5 wt. % ethylene glycol dimethacrylate (EGDMA) and 3 wt. % hydroxyethyl methacrylate (HEMA).

Preparation Example 1 for RFL 403A

Microgel based on hydroxyl-modified SBR, prepared by direct emulsion polymerization using the crosslinking comonomer ethylene glycol dimethacrylate

350 g of the Na salt of a long-chain alkylsulfonic acid (368.4 g Mersolat K30/95 from Bayer A G) and 27 g of the Na salt of methylene-bridged naphthalenesulfonic acid (Baykanol PQ from Bayer AG) were dissolved in 2.03 kg water and the solution was initially introduced into a 5 I autoclave. The autoclave was evacuated and charged with nitrogen three times. Thereafter, 872 g butadiene, 274 g styrene, 69 g ethylene glycol dimethacrylate (90%) and 38.5 g hydroxyethyl methacrylate (96%) were added. The reaction mixture was heated up to 30° C., while stirring. An aqueous solution containing 25 g water, 180 mg ethylenediaminetetraacetic acid (Merck-Schuchardt) and 150 mg iron(II) sulfate*7H₂O, 400 mg Rongalit C (Merck-Schuchardt) and 500 mg trisodium phosphate*12H₂O was then metered in. The reaction was started by addition of an aqueous solution of 350 mg p-menthane hydroperoxide (Trigonox NT 50 from Akzo-Degussa) and 25 g Mersolat K30/95, dissolved in 25 g water. After a reaction time of 2.5 hours the reaction temperature was increased to 40° C. After a reaction time of 5 hours the mixture was after-activated with an aqueous solution consisting of 25 g water, in which 25 g Mersolat K30/95 and 350 mg p-menthane hydroperoxide (Trigonox NT 50) were dissolved. When a polymerization conversion of 95-99% was reached, the polymerization was stopped by addition of an aqueous solution of 2.5 g diethylhydroxylamine, dissolved in 50 g water. Thereafter, unreacted monomers were removed from the latex by stripping with steam. The latex was filtered and, as in example 2 of U.S. Pat. No. 6,399,706, stabilizer was added and the product was coagulated and dried.

RFL 403B contains 80 wt. % styrene, 12 wt. % butadiene, 5 wt. % ethylene glycol dimethacrylate (EGDMA) and 3 wt. % hydroxyethyl methacrylate (HEMA). RFL 403B is prepared analogously to RFL 403A, 996 g styrene, 149 g butadiene, 62 g ethylene glycol dimethacrylate and 37 g hydroxyethyl methacrylate being employed in the polymerization. For the preparation of the composition according to the present invention, Desmophen 1150 was initially introduced into the mixing vessel and RFL 403A and Tego Airex 980 were added, while stirring by means of a dissolver. The mixture was left to stand for one day and then further processed with the homogenizer.

The composition according to the present invention was introduced into the homogenizer at room temperature and passed through the homogenizer 19 times in batch operation under 900 to 1,000 bar. During the first passage the composition heats up to approx. 40° C., and during the second passage to approx. 70° C. It was ensured that the temperature of the composition did not exceed 120° C., which was realized by cooling in a refrigerator.

The average particle diameter of the microgel particles was measured by an LS 230 Beckman-Coulter apparatus by means of laser light scattering. The d50 value of the microgel particles is 112 μm before the homogenization and 220 nm after the homogenization.

The (theoretical) primary particle diameter of 70 nm is achieved in 10% of the particles in the composition. It is to be noted here that, in contrast to the ultracentrifuge, static laser light scattering does not give absolute values. The values in this composition have a tendency to be too high.

The LS 230 Beckman-Coulter apparatus uses as the measurement method a static method, laser diffractometry (LD). The measurement range can be extended from 2,000 μm down to 40 nm by linking in PIDS technology (PIDS: polarization intensity differential scattering).

### Example 2

### SBR Gels Modified with Hydroxyl Groups (RFL 403A) in Desmophen RC-PUR KE 8306

In the example described below it is shown that compositions according to the invention which contain particles or particle agglomerates having particle diameters chiefly in the range from 50 nm to 500 nm, at an average particle diameter of approx. 250 μm, can be prepared using microgels based on SBR and modified with hydroxyl groups in a homogenizer by application of 900 to 1,000 bar.

The composition of the microgel paste is shown in the following table:

| | | |
|---|---|---|
| 1. | RC-PUR KE 8306 | 93.3 |
| 2. | Byk-LP X 6331 | 0.2 |
| 3. | RFL 403A | 6.5 |
| | Total | 100 |

RC-PUR KE 8306 is an activated polyol blend for the preparation of PU by the cold-cast process from RheinChemie Rheinau GmbH.

RC-DUR 120, an aromatic polyisocyanate from RheinChemie Rheinau GmbH, is employed as the crosslinking component.

Byk-LP X 6331 is a deaerating agent for PU systems from Byk-Chemie GmbH.

RFL 403A is a crosslinked, surface-modified rubber gel based on SBR from RheinChemie Rheinau GmbH. RFL 403B has been described above.

For the preparation of the composition according to the present invention, RC PUR KE 8306 was initially introduced into the mixing vessel and Byk-LP X 6331 and RFL 403A or RFL 403B were added, while stirring. The mixture was left to stand for at least one day and then further processed with the homogenizer.

The composition according to the present invention was added into the homogenizer at room temperature and passed through the homogenizer 2 times in batch operation under 900 to 1,000 bar. During the first passage the microgel paste heats up to approx. 40° C., and during the second passage to approx. 70° C.

Thereafter, the composition according to the present invention was reacted with RC-DUR 120 to give a polymer which belongs to the class of cold-cast elastomers.

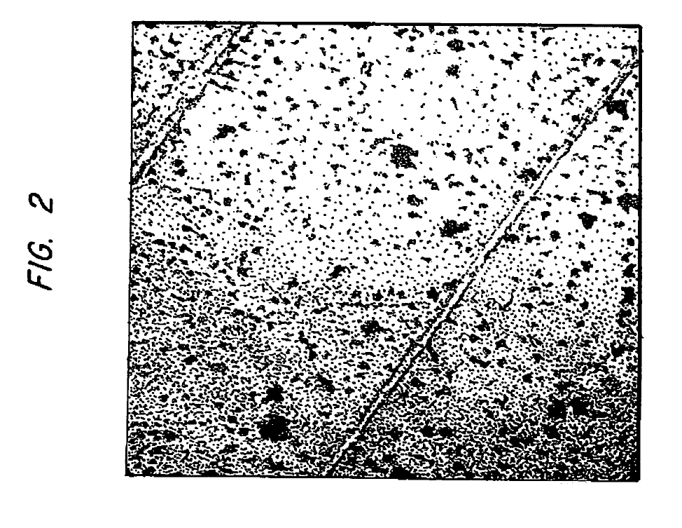

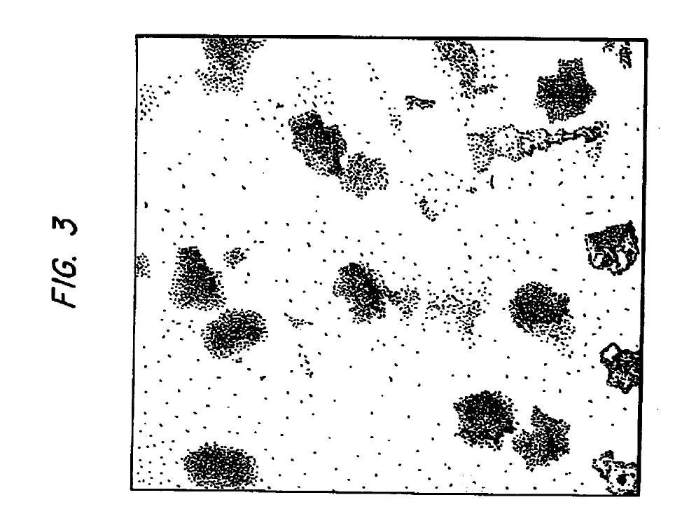

The particle sizes of the rubber gel particles and agglomerates and the structure of the rubber gel agglomerate in the PU-E obtained were analysed by means of TEM photographs (see FIGS. 2 and 3).

Due to the particularly homogeneous distribution of the microgels in the polyol component of RC-PUR KE 8306, particular properties, such as an improved tear propagation resistance and better impact strength, are achieved (see the following table).

| | MG | | Tear propagation | Impact |
|---|---|---|---|---|
| | content | Shore D | resistance | strength |
| | [%] | [−] | [N/mm] | [kJ/m²] |
| KE 8306 | 0¹⁾ | 82 | 29 | 48 |
| KE 8306 | 5¹⁾ | 82 | 47 | 62 |
| KE 8306 | 10¹⁾ | 81 | 51 | 65 |
| KE 8306 | 10²⁾ | 83 | 43 | — |

¹⁾RFL 403A
²⁾RFL 403B

Demonstration of the Morphology

The morphology is demonstrated with the aid of transmission electron microscopy (TEM) photographs.

1. TEM:

Sample preparation for the transmission electron microscopy analyses.

Cryo-ultramicrotomy

Procedure:

Thin sections having a section thickness of approx. 70 nm were prepared under cryo-conditions by means of a diamond blade. Contrasting with OsO₄ was performed on individual thin sections to improve the contrast.

The thin sections were transferred to copper gauzes, dried and initially evaluated over a large area by TEM. Thereafter, with an acceleration voltage of 80 kV under 12,000-fold magnification, area shown=833.7*828.8 nm, characteristic image sections were stored by means of digital imaging software for documentation purposes.

The TEM photographs show that particles or particle agglomerates having particle diameters chiefly in the range from 50 nm to 500 nm, at an average particle diameter of approx. 250 μm, are present, while after incorporation of the microgels by means of a dissolver, according to experience the average particle diameter is approx. 120 μm.

The particle sizes determined directly in this example support the values determined in example 1 indirectly in the rubber gel paste (D) by means of laser diffractometry (LD).

Due to the particularly fine distribution of the microgels in the matrix of the plastic, improved properties, such as higher tear propagation resistances and higher impact strengths, were achieved.

### Example 3

### SBR Gels Modified with Hydroxyl Groups (RFL 403B or RFL 403A) in RC-Phen E 123

In the example described below it is shown that using microgels based on SBR and modified with hydroxyl groups, compositions according to the present invention which have been dispersed with the homogenizer show improved properties after curing, which are due to the nanoparticles.

The following table shows by way of example the composition of a microgel paste with nineteen percent of microgel:

| | | |
|---|---|---|
| 1. | RC-Phen 123 | 75.127 |
| 2. | Aktivator 105E | 0.0613 |
| 2. | Byk-LP X 6331 | 0.283 |
| 3. | RFL 403B | 18.868 |
| | T-Paste | 5.660 |
| | Total | 100 |

The blends used differ in the amount and nature of the microgel added.

RC-Phen E 123 is a non-activated polyol blend for the preparation of PU by the cold-cast process from RheinChemie Rheinau GmbH. RC-DUR 110, an aromatic polyisocyanate from RheinChemie Rheinau GmbH, is employed as the crosslinking component.

RC-PUR Aktivator 105E is a PU additive from RheinChemie Rheinau GmbH.

Byk-LP X 6331 is a deaerating agent for PU systems from Byk-Chemie GmbH.

RFL 403A is a crosslinked, surface-modified rubber gel based on SBR from RheinChemie Rheinau GmbH.

T-Paste is a commercial product from UOP. For the preparation of the composition according to the present invention, RC-Phen E 123 was initially introduced into the mixing vessel and RC-PUR Aktivator 105E, Byk-LP X 6331, RFL 403A and T-Paste were added, while stirring. The mixture was left to stand for at least one day and then further processed with the homogenizer.

The composition according to the present invention was introduced into the homogenizer at room temperature and passed through the homogenizer 2 times in batch operation under 900 to 1,000 bar. During the first passage the microgel paste heats up to approx. 40° C., and during the second passage to approx. 70° C.

Thereafter, the composition according to the present invention was reacted with RC-DUR 110 to give a polymer which belongs to the class of cold-cast elastomers.

Particular properties, such as an improved tear propagation resistance, strengthening, higher hardness and higher rebound resilience, are achieved by the addition of the microgels in the polyol component of RC-Phen E 123 (see the following table and figures).

TABLE
Stress σₓ at 50%, 100% and 200% elongation for the system
“RC-Phen 123 - RFL 403A - RC DUR 110”.

| Microgel | | | | |
|---|---|---|---|---|
| content | Stress σ₅₀ | Stress σ₁₀₀ | Stress σ₂₀₀ | |
| [%] | [MPa] | [MPa] | [MPa] | Comments |
| 0 | 0.7 | 1.0 | 1.5 | dispersed |
| | | | | 25 |
| 0 | 0.7 | 1.0 | 1.6 | with 2.2% |
| | | | | Omyalite 90 |
| 3.1 | 0.7 | 1.1 | 1.7 | |
| 6.1 | 0.9 | 1.3 | 2.1 | |
| 12 | 0.7 | 1.2 | 2.0 | 30 |

The strengthening effect of RFL 403A becomes clear at the stresses σₓ at 200% elongation.

TABLE
Hardness, rebound resilience and tear propagation resistance
for the system RC-Phen 123 - RFL 403A - RC DUR 110.

| Microgel | | Rebound resilience | |
|---|---|---|---|
| content | Hardness | at 20° C. | |
| [%] | [ShA] | [%] | Comments |
| 0 | 46 | 49 | dispersed |
| 0 | 47 | 50 | with 2.2% |
| | | | Omyalite 90 |
| 3.1 | 50 | 52 | dispersed |
| 6.1 | 52 | 50 | dispersed |
| 12 | 49 | 51 | dispersed |

Of interest is the increase in the rebound resilience, although the system RC-Phen E 123 is already highly elastic.

TABLE
Stress σₓ at 50%, 100% and 200% elongation for the system
“RC-Phen 123 - RFL 403B - RC DUR 110”

| Microgel | Stress | Stress | Stress | Stress | Breaking |
|---|---|---|---|---|---|
| content | σ₅₀ | σ₁₀₀ | σ₂₀₀ | σ₃₀₀ | stress σ_{B} |
| [%] | [MPa] | [MPa] | [MPa] | [MPa] | [MPa] |
| 0 | 0.7 | 1.1 | 1.7 | 2.5 | 4.6 |
| 2.5 | 0.8 | 1.2 | 2.0 | 3.1 | 6.8 |
| 5 | 0.9 | 1.4 | 2.3 | 3.6 | 6.3 |
| 7.5 | 0.9 | 1.4 | 2.4 | 3.8 | 7.6 |
| 20 | 1.5 | 2.3 | 4.1 | 6.5 | 10.1 |
| 25 | 2.2 | 3.4 | 6 | 9.7 | 10.3 |

The strengthening effect of RFL 403B is highly pronounced at all elongations.

### Example 4

### SBR Gels Modified with Hydroxyl Groups (OBR 1212) in Desmophen 1600U

In the example described below it is shown that using microgels based on SBR and modified with hydroxyl groups compositions according to the present invention which chiefly comprise primary particles having an average particle diameter chiefly of approx. 60 nm can be prepared in a homogenizer by application of 900 to 1,000 bar.

The composition of the microgel paste is shown in the following table:

| | | |
|---|---|---|
| 1. | Desmophen 1600U | 90,000 |
| 2. | OBR 1212 | 10,000 |
| | Total | 100,000 |

Desmophen 1600U is a commercial productipolyol (polyether) from Bayer AG.

OBR 1212 is a crosslinked, surface-modified rubber gel based on SBR from RheinChemie Rheinau GmbH.

For the preparation of the composition according to the present invention, Desmophen 1600U was initially introduced into the mixing vessel and OBR 1212 was added, while stirring by means of a dissolver. The mixture was left to stand for at least one day and then further processed with the homogenizer.

The composition according to the present invention was added into the homogenizer at room temperature and passed through the homogenizer 4 times in batch operation under 900 to 1,000 bar. During the first passage the microgel paste heats up to approx. 40° C., and during the second passage to approx. 70° C. Thereafter, the microgel paste was cooled to room temperature and dispersing was carried out a third and fourth time.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Composition comprising at least one crosslinkable organic medium (A) which has a viscosity of less than 1,000 mPas at a temperature of 120° C. and at least one microgel (B) which is not crosslinked by high-energy radiation.

2. Composition according to claim 1, the microgel (B) primary particles having an approximately spherical geometry.

3. Composition according to claim 2, characterized in that the deviation of diameter of an individual primary particle of the microgel (B), defined as
[(d1−d2)/d1]×100
wherein d1 and d2 are any two desired diameters of the primary particle and d1>d2, is less than 250%.

4. Composition according to claim 2, characterized in that the primary particles of the microgel (B) have an average particle size of 5 to 500 nm.

5. Composition according to claim 1, wherein the microgels (B) have contents which are insoluble in toluene at 23° C. of at least about 70 wt. %.

6. Composition according to claim 1, wherein the microgels (B) have a swelling index in toluene at 23° C. of less than about 80.

7. Composition according to claim 1, wherein the microgels (B) have glass transition temperatures of −100° C. to +100° C.

8. Composition according to claim 1, wherein the microgels (B) have a width of the glass transition range of greater than about 5° C.

9. Composition according to claim 1, wherein the microgels (B) are prepared by emulsion polymerization.

10. Composition according to claim 1, wherein the microgel (B) is based on rubber.

11. Composition according to claim 1, wherein the microgel (B) is based on homopolymers or random copolymers.

12. Composition according to claim 1, wherein the microgel (B) is modified by functional groups which are reactive with C═C double bonds.

13. Composition according to claim 1, wherein the crosslinkable organic medium (A) is crosslinkable with heteroatom-containing functional groups or C═C groups.

14. Composition according to claim 1, wherein the microgel (B) is 1 to 60 wt. % of the composition, based on the total weight of the composition.

15. Composition according to claim 1, wherein the crosslinkable organic medium (A) is 10 to 99 wt. % of the composition, based on the total weight of the composition.

16. Composition according to claim 1, further comprising fillers and additives.

17. Composition according to claim 1, wherein the composition has a viscosity of 25 mPas up to 5,000,000 mPas at a speed of 5 s⁻¹, determined with a ball-plate measuring system in accordance with DIN 53018, at 20° C.

18. Process for the preparation of microgel-containing polymers comprising polymerizing the composition according to claim 1.

19. Process for the production of shaped articles or coatings by shaping or coating comprising processing the compositions according to claim 1.

20. Process for the preparation of the composition according to claim 1, comprising trating components (A) and (B) together with a homogenizer, a bead mill or a triple-roll mill.

21. Arrangement comprising in a form separated spatially from one another, the composition according to claim 1 and a composition comprising a crosslinking agent for the crosslinkable organic medium (A).

22. A microgel containing polymer comprising the composition according to claim 1.

23. A shaped article comprising the composition according to claim 1.

24. A coating comprising the composition according to claim 1.
